(19) United States
(12) Patent Application Publication
(10) Pub. No.: US 2026/0357767 A1
(43) Pub. Date: Nov. 12, 2026

(54) DYNAMIC SUBMERGED SIDE AIR INLET FOR RAMJET MISSILE

(71) Applicant: BAE Systems Information and Electronic Systems Integration Inc., Nashua, NH (US)

(72) Inventors: Jacob W. Miska, Nashua, NH (US); Matthew F. Chrobak, Groton, MA (US); Hailey J. Miller, Belmont, MA (US); Jason H. Batchelder, Nashua, NH (US)

(73) Assignee: BAE Systems Information and Electronic Systems Integration Inc., Nashua, NH (US)

(21) Appl. No.: 19/199,605

(22) Filed: May 6, 2025

(51) Int. Cl. F02K 7/10; F42B 15/10

(52) U.S. Cl. CPC F02K 7/10; F42B 15/10

(57) ABSTRACT

A controllable air inlet system for an aeronautical platform. A system implementing the techniques according to an embodiment includes an actuator plate disposed within a housing of the platform and configured to move forward and rearward along a longitudinal axis of the platform in response to rotation of a lead screw. The system also includes an inlet panel configured to pivot between a first panel position and a second panel position in response to movement of the actuator plate, the first panel position flush with the housing and the second panel position interior to the housing. The system further includes an air scoop configured to move between a first scoop position and a second scoop position in response to movement of the actuator plate, the first scoop position flush with the housing and the second scoop position exterior to the housing.

### FIELD OF DISCLOSURE

The present disclosure relates to aeronautical platforms, and more particularly to a controllable air inlet system for a ramjet missile.

### BACKGROUND

Aeronautical platforms such as missiles may employ rocket motors that are powered by a combination of solid fuel propulsion and ramjet propulsion. While solid fuel does not generally require an air supply for combustion, ramjet propulsion typically employs a high pressure air flow that is guided through the rocket motor to combust with the ramjet fuel. Directing airflow into the missile through the nose of the platform, however, can be problematic since the nose is often used to house guidance systems (e.g., sensors, electronics, and the like).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an aeronautical platform, including side inlets, configured in accordance with certain embodiments of the present disclosure.

FIG. 2 provides a perspective view of the aeronautical platform of FIG. 1 in a closed inlet configuration, in accordance with certain embodiments of the present disclosure.

FIG. 3 provides a perspective view of the aeronautical platform of FIG. 1 in an open inlet configuration, in accordance with certain embodiments of the present disclosure.

FIG. 4 provides a cross-section view of an inlet assembly, configured in accordance with certain embodiments of the present disclosure.

FIG. 5 provides another cross-section view of the inlet assembly of FIG. 4, configured in accordance with certain embodiments of the present disclosure.

FIG. 6 provides a perspective view of the components of the inlet assembly of FIG. 4, configured in accordance with certain embodiments of the present disclosure.

FIGS. 7A and 7B provide perspective views of a ball and socket linkage of FIG. 5, configured in accordance with certain embodiments of the present disclosure.

FIG. 8 provides a perspective view of the inlet in a closed configuration, in accordance with certain embodiments of the present disclosure.

FIG. 9 provides a cross-section view of the inlet in the process of opening, in accordance with certain embodiments of the present disclosure.

FIG. 10 provides another cross-section view of the inlet in the process of opening, in accordance with certain embodiments of the present disclosure.

FIG. 11 illustrates airflow during open inlet configuration, in accordance with certain embodiments of the present disclosure.

FIG. 12 provides a cross-section view of the inlet in the process of closing, in accordance with certain embodiments of the present disclosure.

FIG. 13 provides another cross-section view of the inlet in the process of closing, in accordance with certain embodiments of the present disclosure.

FIG. 14 is a flowchart illustrating a methodology for fabrication of a controllable air inlet system for an aeronautical platform, in accordance with an embodiment of the present disclosure.

Although the following Detailed Description will proceed with reference being made to illustrative embodiments, many alternatives, modifications, and variations thereof will be apparent in light of this disclosure. The features depicted in the drawings are not necessarily drawn to scale or otherwise intended to be limited to the precise forms shown.

### DETAILED DESCRIPTION

Techniques are provided herein for a controllable air inlet system for a ramjet missile that can be dynamically deployed from or submerged into the missile housing. As noted above, aeronautical platforms such as missiles, rockets and precision guided munitions may employ rocket motors that are powered by a combination of solid fuel propulsion and ramjet propulsion. While solid fuel does not generally require an air supply for combustion, ramjet propulsion typically employs a high pressure air flow that is guided through the rocket motor to combust with the ramjet fuel. Directing airflow into the missile through the nose of the platform, however, can be problematic since the nose is often used to house guidance systems (e.g., sensors, electronics, and the like).

To this end, and in accordance with an embodiment of the present disclosure, a dynamically controllable air inlet system is provided for an aeronautical platform, such as a missile or other projectile, that includes ramjet propulsion capabilities. The system includes one or more air scoops located circumferentially around the housing of the platform, rather than in the nose cone, and provides for dynamic deployment of the air scoops such that they can be closed (e.g., flush with the housing) or open (e.g., pivoted, pushed, or otherwise moved outward from the housing). When in the open position, the air scoops allow air flow to be directed into the platform towards the ramjet fuel. When in the closed position, the air flow is cut off allowing for velocity control and improvement of the platform aerodynamics and maneuverability.

In accordance with an embodiment, a system implementing the techniques providing a dynamically controllable air inlet for an aeronautical platform includes an actuator plate disposed within a housing of the platform. The actuator plate is configured to move forward and rearward along a longitudinal axis of the platform in response to rotation of a lead screw which may be controlled by an actuator such as a stepper motor. The system also includes an inlet panel configured to pivot between a first panel position and a second panel position in response to movement of the actuator plate. The first panel position is flush with the housing and the second panel position is interior to the housing. The system further includes an air scoop configured to move between a first scoop position and a second scoop position in response to movement of the actuator plate. The first scoop position is flush with the housing and the second scoop position is exterior to the housing. The first panel position and the first scoop position are configured to prevent airflow into the platform, to control propulsion and to increase aerodynamic efficiency and maneuverability of the platform, while the second panel position and the second scoop position are configured to direct airflow into the platform for combustion by a ramjet motor.

It will be appreciated that the techniques described herein may provide improved propulsion control and maneuverability for an aeronautical platform, compared to other methods that employ fixed air inlets and/or air inlets located in the nose cone. Numerous embodiments and applications will be apparent in light of this disclosure.

### System Architecture

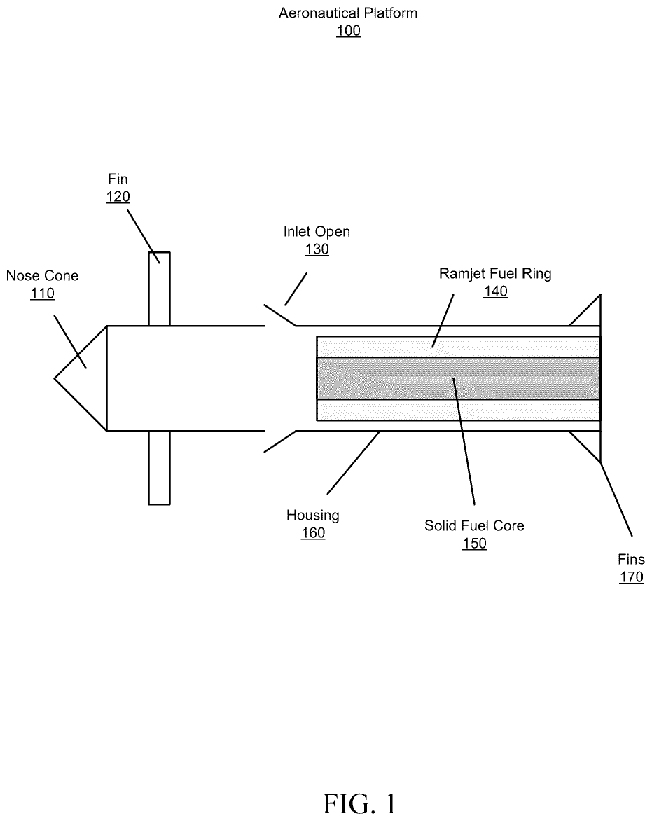

FIG. 1 illustrates an aeronautical platform 100, including side inlets, configured in accordance with certain embodiments of the present disclosure. The aeronautical platform 100 is shown to include a nose cone 110, fins 120, housing 160, an air inlet 130 (shown in an open position), a ramjet fuel ring 140, and a solid fuel core 150.

The nose cone 110 may be configured in a shape that provides desired aerodynamic qualities to the platform 100 and may also contain guidance systems that include sensors and associated electronics. One advantage of the disclosed techniques for a controllable air inlet system is that the air inlet system is not located in or near the nose cone 110 or otherwise impact the aerodynamic qualities of the platform 100 or the operation of any guidance systems deployed within the nose cone 110.

In some embodiments, one or more fins 120 may be employed to provide aerodynamic stability. In some embodiments, the fin positions and orientations may be adjusted by actuators, for example under the control of a guidance system, to maneuver the platform towards a target. In some embodiments, additional fixed fins 170 may be employed to provide aerodynamic stability.

In some embodiments, the platform 100 comprises a cylindrical housing 160, within which rocket fuel is contained. In this example, a solid fuel core 150 is shown to be encapsulated by a ring of ramjet fuel 140, although other configurations are possible. The solid fuel core 150, once ignited, burns without the need for an air supply. The ramjet fuel, however, does require an air supply which may be provided through the air inlet 130. When the air inlet 130 is in the open position, as shown in this figure, a high pressure flow of air (resulting from the platform velocity) is directed into the body of the platform towards the ramjet fuel ring allowing for ramjet fuel combustion.

In some embodiments, the solid fuel core 150 is configured to burn first and provide the initial acceleration for the platform 100, after which the ramjet fuel burns to provide additional acceleration. The relatively high velocity that is thus achieved can increase the range of the platform, which works well while the platform is in an unguided mode of flight. As the platform nears the target, it may be desirable to provide guidance (e.g., by adjusting the fins 120), but the open inlet 130 has an adverse impact on aerodynamic maneuverability and stability at these higher velocities. Additionally, at this point in the flight the ramjet fuel may have been consumed so that there is no further need for airflow into the housing. In some cases, the ramjet fuel may not have been consumed as the platform is reaching the target (e.g., the ramjet is still providing propulsion), but closing the inlet may be desirable to shut down the ramjet and decrease velocity for improved maneuverability on the final approach to the target.

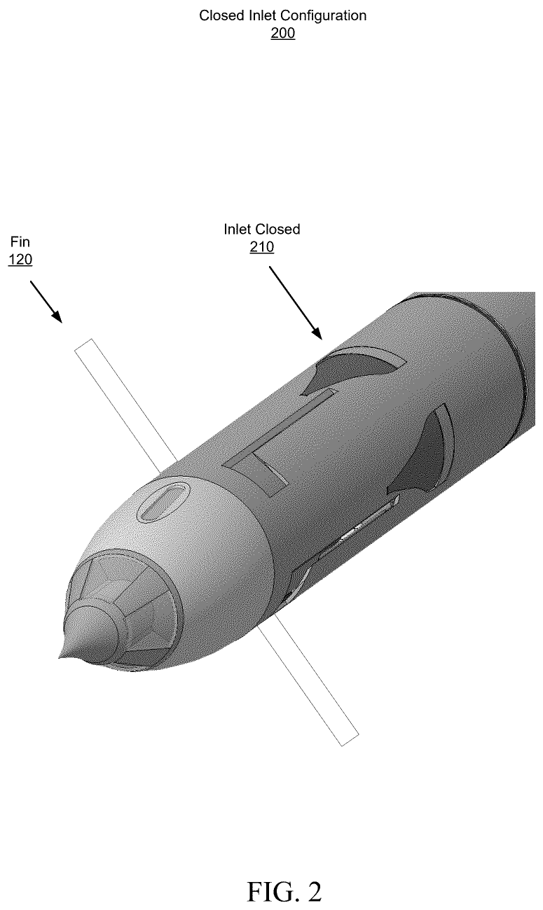

FIG. 2 provides a perspective view of the aeronautical platform 100 of FIG. 1 in a closed inlet configuration 200, in accordance with certain embodiments of the present disclosure. When the inlet is closed 210, a relatively flush surface is achieved to improve the aerodynamic properties of the platform 100. In some examples, the inlets may be closed prior to flight and through launch into the early stage of flight while the solid fuel is providing propulsion. The inlet can also be closed 210 as the aeronautical platform 100 approaches the target or when the ramjet fuel is depleted.

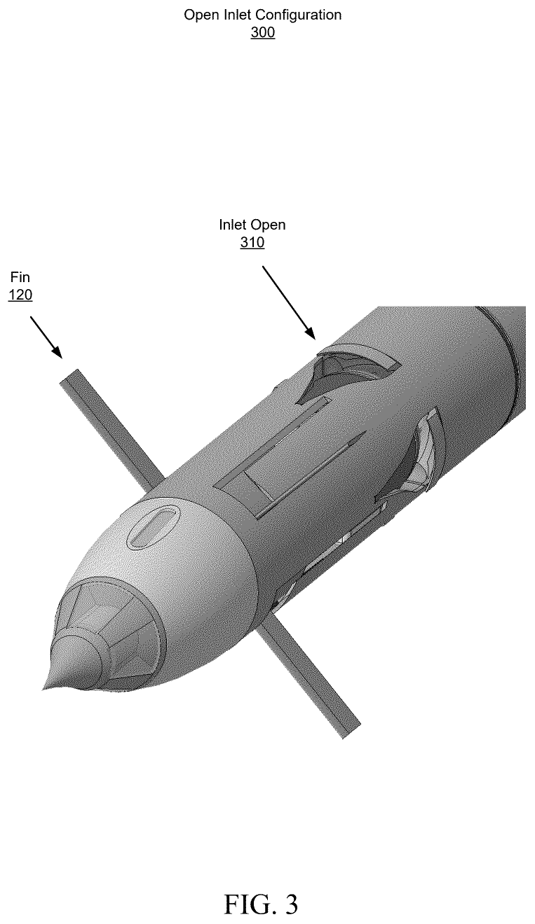

FIG. 3 provides a perspective view of the aeronautical platform 100 of FIG. 1 in an open inlet configuration 300, in accordance with certain embodiments of the present disclosure. When the inlet is open 310, airflow is directed into the platform to allow for combustion with the ramjet fuel ring 140. In some examples, the inlets may be opened after the solid fuel has been consumed.

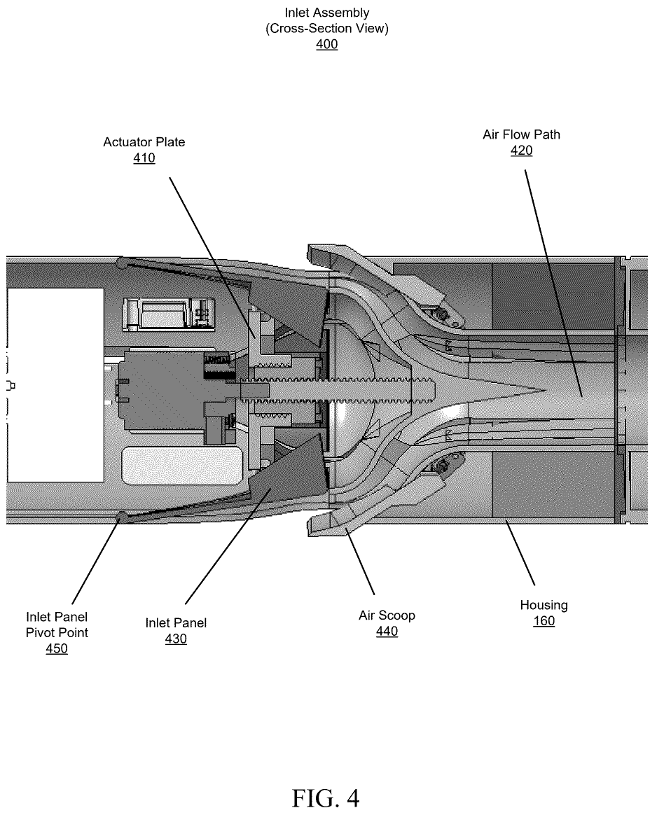

FIG. 4 provides a cross-section view 400 of an inlet assembly, configured in accordance with certain embodiments of the present disclosure. The inlet assembly 400 is shown to include an actuator plate 410, an inlet panel 430, an air scoop 440, and the housing 160. An airflow path 420 is also shown, through which air flows to the ramjet 140 when the air scoop 440 and inlet panel 430 are in the open configuration.

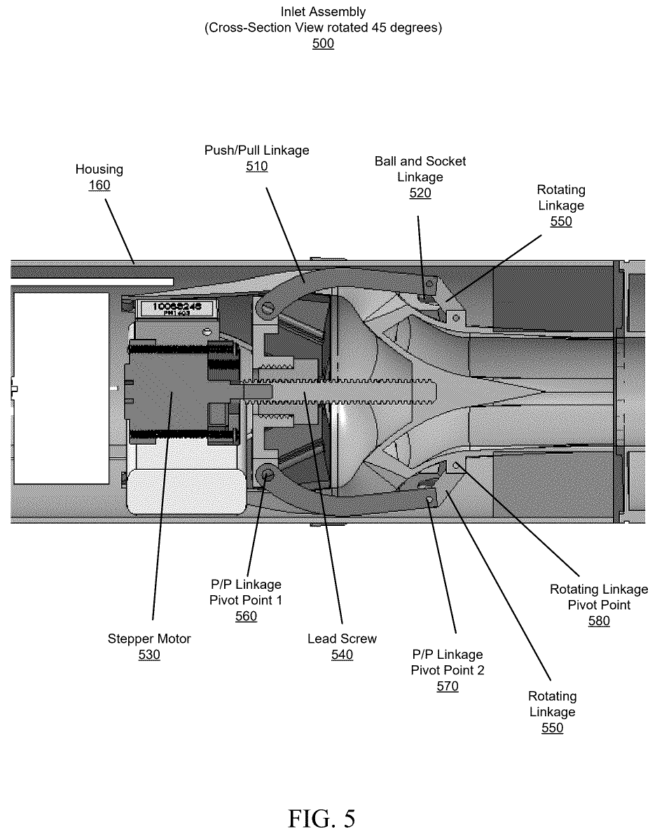

The actuator plate 410 is disposed within the housing 160 and configured to move forward and rearward along a longitudinal axis of the platform 100 in response to rotation of the lead screw (e.g., lead screw 540 of FIG. 5). The actuator plate 410 is oriented orthogonally to the longitudinal axis of the platform

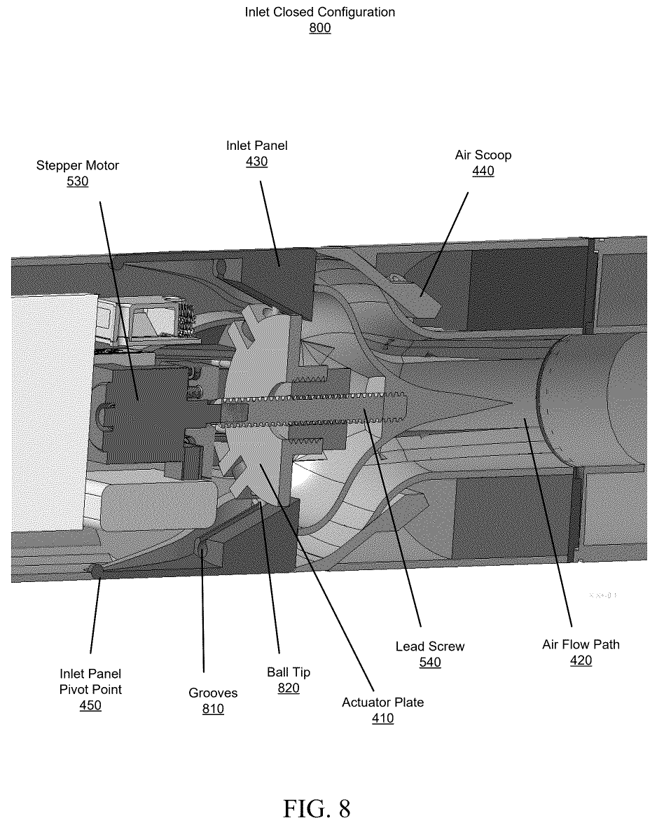

The inlet panel 430 is configured to pivot, about a fixed pivot point 450, between a first panel position and a second panel position in response to movement of the actuator plate 410. This pivoting operation is described in greater detail in connection with FIG. 8. The first panel position is substantially flush with the housing 160 and the second panel position is interior to the housing 160 (as shown in this figure).

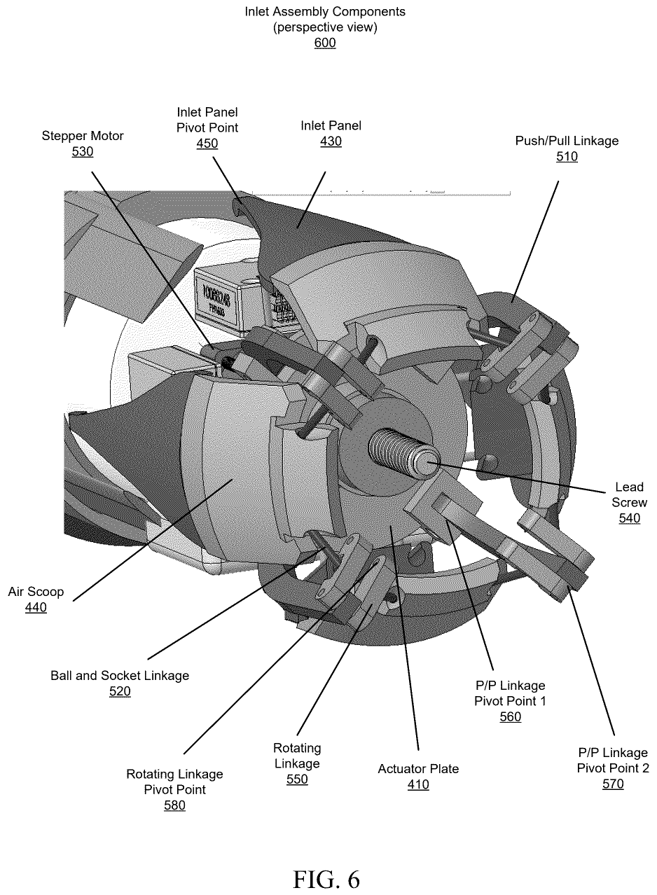

The air scoop 440 configured to move between a first scoop position and a second scoop position in response to movement of the actuator plate 410. This movement operation is described in greater detail in connection with FIGS. 5 and 6. The first scoop position is substantially flush with the housing 160 and the second scoop position is outwardly exterior to the housing 160 (as shown in this figure).

The first panel position and the first scoop position are configured to prevent airflow into the platform to control propulsion and to increase aerodynamic efficiency and maneuverability of the platform. The second panel position and the second scoop position are configured to direct airflow into the platform for combustion by the ramjet motor.

FIG. 5 provides another cross-section view 500 of the inlet assembly of FIG. 4, configured in accordance with certain embodiments of the present disclosure. This cross-section view is rotated by about 45 degrees relative the view in FIG. 4. Shown in this view are a push/pull linkage 510, a ball and socket linkage 520, a stepper motor 530, a lead screw 540, a rotating linkage 550, a first push/pull linkage pivot point 560, a second push/pull linkage pivot point 570, and a rotating linkage pivot point 580.

The stepper motor 530 is configured to rotate the lead screw 540 to cause the actuator plate 410 to move either forward (e.g., towards the nose cone) or rearward (e.g., away from the nose cone) depending on the rotation direction.

The actuator plate 410 is coupled to the air scoop 440 through a linkage mechanism that includes the push/pull linkage 510, the ball and socket linkage 520, and the rotating linkage 550, which are illustrated and described in greater detail in FIG. 6. The push/pull linkage 510 is coupled to the actuator plate 410 at the first push/pull linkage pivot point 560, and to the rotating linkage 550 at the second push/pull linkage pivot point 570. The rotating linkage 550 is coupled to the interior of the housing at the rotating linkage pivot point 580. The linkage mechanism and pivot points are configured such that movement of the actuator plate causes the air scoop 440 to move between a first scoop position and a second scoop position.

FIG. 6 provides a perspective view 600 of the components of the inlet assembly of FIG. 4, without the housing 160, configured in accordance with certain embodiments of the present disclosure and shows the closed configuration with the inlet panel 430 in close contact with the air scoop 440 and the inlet panel 430 substantially flush with the housing. Shown in this view are the stepper motor 530, the inlet panel 430, the inlet panel pivot point 450, the push/pull linkage 510, the first push/pull linkage pivot point 560, the second push/pull linkage pivot point 570, the air scoop 440, the ball and socket linkage 520, the rotating linkage 550, the rotating linkage pivot point 580, the actuator plate 410, and the lead screw 540.

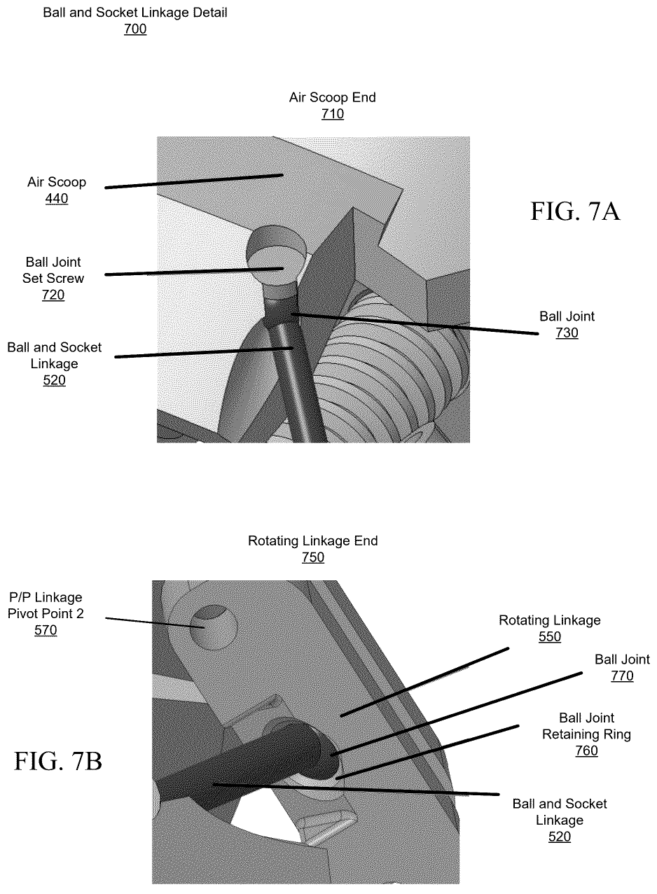

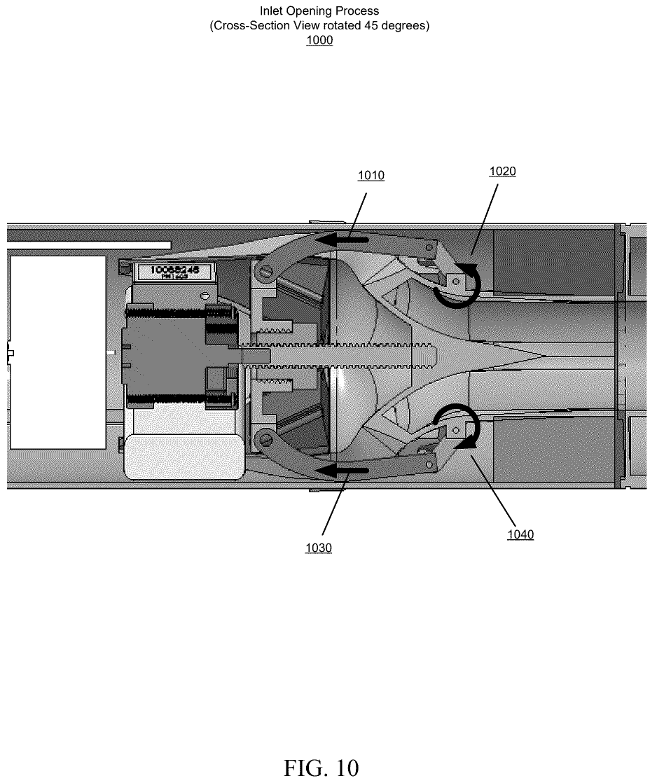

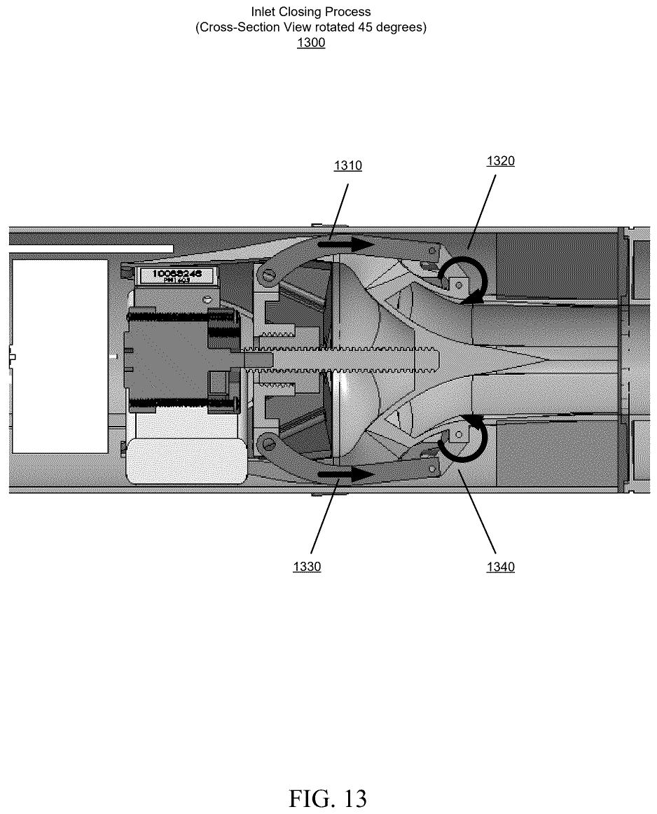

One end of the push/pull linkage 510 is coupled to the first push/pull linkage pivot point 560 on the actuator plate. The opposite end of the push/pull linkage 510 is coupled to the rotating linkage 550 at the second push/pull linkage pivot point 570. The ball and socket linkage 520 is configured to couple the rotating linkage 550 to the air scoop 440. The ball and socket linkage 520 is illustrated and described in greater detail in FIGS. 7A and 7B. Motion of the actuator plate 410 (e.g., forward or rearward) is translated through the push/pull linkage 510, the rotating linkage 520, and the ball and socket linkage 520 to cause the air scoop 440 to move (e.g., outward or inward from the housing), as illustrated below in FIGS. 10 and 13.

FIGS. 7A and 7B provide perspective views 700 of the ball and socket linkage 520 of FIG. 5, configured in accordance with certain embodiments of the present disclosure. The ball and socket linkage 520 is configured to couple the rotating linkage 550 to the air scoop 440, using ball joints 730 and 770, such that rotation of the rotating linkage 550 causes the air scoop 440 to move inward or outward of the housing. As the rotating linkage 550 rotates about pivot points 570 and 580, the rotating linkage pushes or pulls on the air scoop via the ball and socket linkage 520.

FIG. 7A illustrates one end 710 of the ball and socket linkage, which is coupled to the air scoop 440, and is shown to include the air scoop 440, ball joint 730, a ball joint set screw 720, and the ball and socket linkage 520.

The ball joint 730 is attached to the end 710 of the linkage 520 and configured to be received in a socket of the air scoop 440 such that it can rotate. The ball joint set screw 720 is configured to secure the ball joint 730 within the socket.

FIG. 7B illustrates the opposite end 750 of the ball and socket linkage, which is coupled to the rotating linkage 550, and is shown to include the rotating linkage 550, ball joint 770, a ball joint retaining ring 760, and the ball and socket linkage 520.

The ball joint 770 is attached to the end 750 of the linkage 520 and configured to be received in a socket of the rotating linkage 550 such that it can rotate. The ball joint retaining ring 760 is configured to secure the ball joint 770 within the socket.

FIG. 8 provides a perspective view of the inlet in a closed configuration 800, in accordance with certain embodiments of the present disclosure. Shown in this view are the stepper motor 530, the inlet panel 430, the inlet panel pivot point 450, the air scoop 440, the actuator plate 410, grooves 810 in the inlet panel 430, ball tips 820 on the actuator plate 410, the lead screw 540, and the air flow path 420.

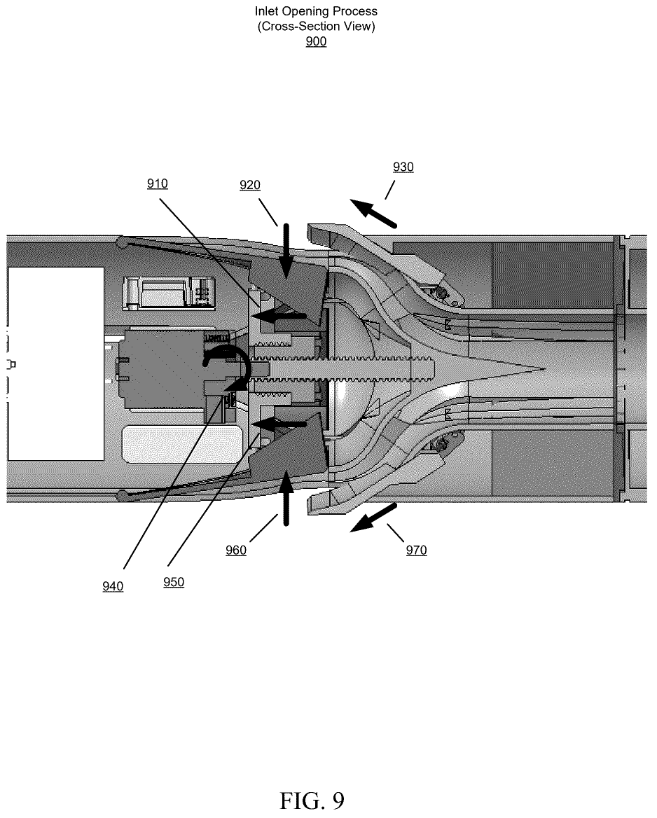

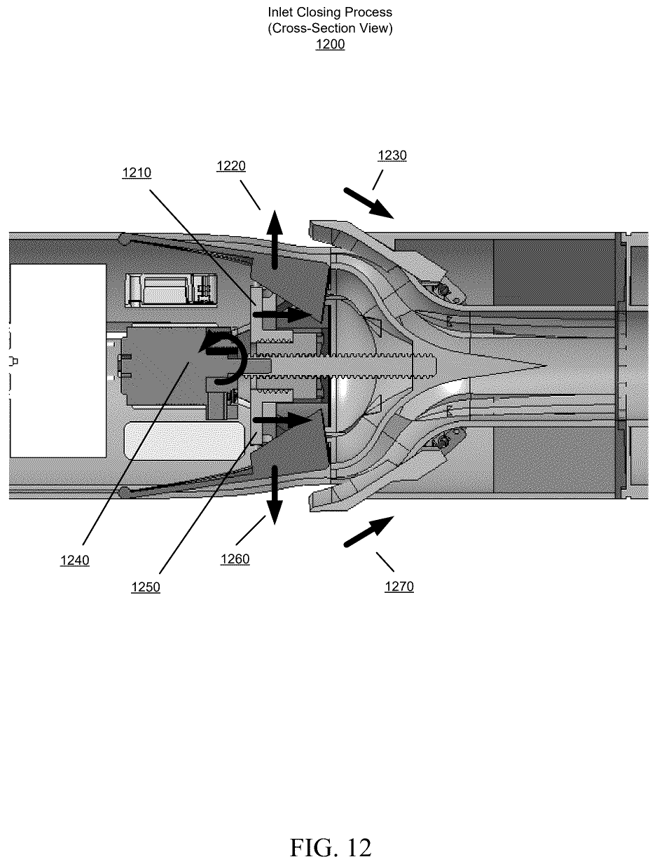

The ball tips 820 are attached points on the circumference of the actuator plate 410. The grooves 810 are etched into the inlet panel 430 and configured to receive the ball tips 820 such that the ball tips 820 can slide within the grooves 810. As such, movement of the actuator plate 410 causes ball tips 820 to travel along the grooves 810 causing the inlet panel 430 to pivot (about the inlet panel pivot point 450) between the first panel position and the second panel position, as illustrated below in FIGS. 9 and 12.

FIG. 9 provides a cross-section view of the inlet in the process of opening 900, in accordance with certain embodiments of the present disclosure. The motions of the various components during the opening process are indicated by the bold arrows 910, 920, 930, 940, 950, 960, and 970. For example, as the lead screw rotates 940, the actuator plates 410 move forward (910 and 950), causing the inlet panels 430 to pivot (about pivot point 450) inward (920 and 960). Additionally, the air scoops 440 move outward (930 and 970) due to motion of the linkage mechanisms (push/pull linkage 510 and rotating linkage 550) as described below in connection with FIG. 10.

FIG. 10 provides another cross-section view of the inlet in the process of opening 1000, in accordance with certain embodiments of the present disclosure. This cross-section view is rotated by 45 degrees relative the view in FIG. 9. The motions of the various components during the opening process are indicated by the bold arrows 1010, 1020, 1030, and 1040. For example, as the actuator plates 410 move forward, the push/pull linkages 510 rotate about pivot 560 which causes them to move forward (1010 and 1030). The rotating linkages 550 then pivot at pivot points 570 and 580. Rotation around pivot points 580 is shown (1020 and 1040). The resulting movement of the rotating linkages push (via the ball and socket linkage 520) the air scoops 440 outward from the housing.

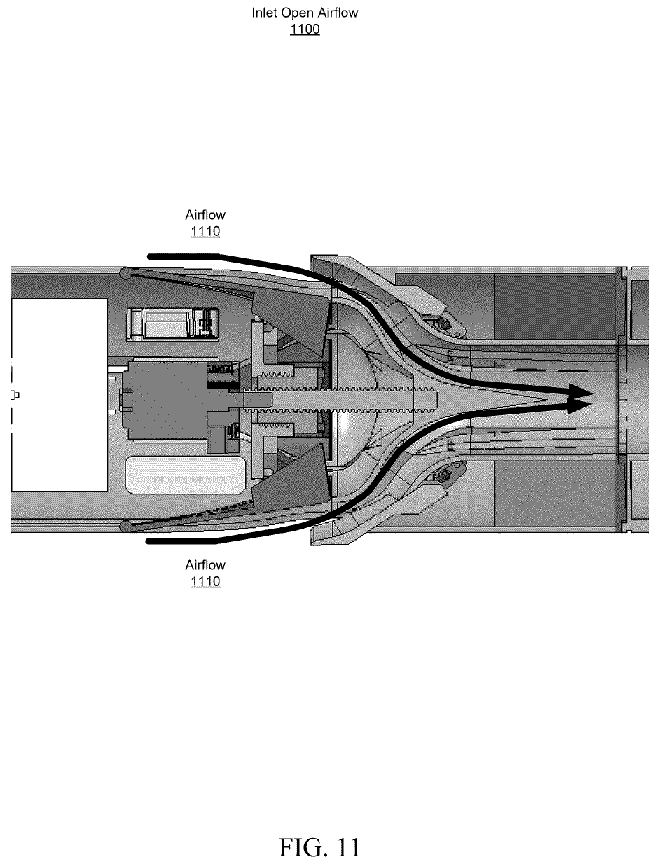

FIG. 11 illustrates airflow 1100 during open inlet configuration, in accordance with certain embodiments of the present disclosure. A high pressure stream of air (due to the velocity of the platform) is directed into the platform and towards the ramjet fuel for combustion.

FIG. 12 provides a cross-section view of the inlet in the process of closing 1200, in accordance with certain embodiments of the present disclosure. The motions of the various components during the closing process are indicated by the bold arrows 1210, 1220, 1230, 1240, 1250, 1260, and 1270. For example, as the lead screw rotates 1240 (in the opposite direction relative to the rotation during the opening process), the actuator plates 410 move rearward (1210 and 1250), causing the inlet panels 430 pivot (about pivot point 450) outward (1220 and 1260). Additionally, the air scoops 440 move inward (1230 and 1270) due to motion of the linkage mechanisms (push/pull linkage 510 and rotating linkage 550) as described below in connection with FIG. 13.

FIG. 13 provides another cross-section view of the inlet in the process of closing 1300, in accordance with certain embodiments of the present disclosure. This cross-section view is rotated by 45 degrees relative the view in FIG. 12. The motions of the various components during the closing process are indicated by the bold arrows 1310, 1320, 1330, and 1340.

For example, as the actuator plates 410 move rearward, the push/pull linkages 510 rotate about pivot 560 which causes them to move rearward (1310 and 1330). The rotating linkages 550 then pivot at pivot points 570 and 580. Rotation around pivot points 580 is shown (1320 and 1340). The resulting movement of the rotating linkages pull (via the ball and socket linkage 520) the air scoops 440 inward from the housing.

### Methodology

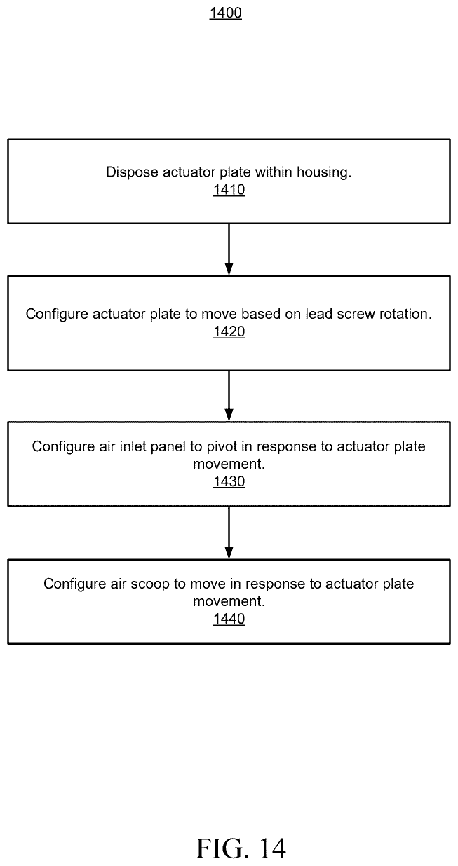

FIG. 14 is a flowchart illustrating a methodology 1400 for fabrication of a controllable air inlet system for an aeronautical platform, in accordance with an embodiment of the present disclosure. As can be seen, example method 1400 includes a number of phases and sub-processes, the sequence of which may vary from one embodiment to another. However, when considered in aggregate, these phases and sub-processes form a process for operation of the GNSS spoofer protection system 210, in accordance with certain of the embodiments disclosed herein, for example as illustrated in FIGS. 1-6, as described above. However other system architectures can be used in other embodiments, as will be apparent in light of this disclosure. To this end, the correlation of the various functions shown in FIG. 14 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 1400 commences, at operation 1410, by disposing an actuator plate within a housing of the platform at an orientation orthogonal to a longitudinal axis of the platform.

At operation 1420, the actuator plate is configured to move forward and rearward along the longitudinal axis of the platform in response to rotation of a lead screw.

At operation 1430, an inlet panel is configured to pivot between a first panel position and a second panel position in response to movement of the actuator plate, the first panel position flush with the housing and the second panel position interior to the housing.

At operation 1440, an air scoop is configured to move between a first scoop position and a second scoop position in response to movement of the actuator plate, the first scoop position flush with the housing and the second scoop position exterior to the housing.

In some embodiments, additional operations may be performed, as previously described in connection with the system. For example, a ball tip is coupled to a point on the circumference of the actuator plate and a groove is etched in the inlet panel. The groove is configured to receive the ball tip such that movement of the actuator plate causes the inlet panel to pivot between the first panel position and the second panel position.

In some embodiments, a linkage mechanism is coupled between the actuator plate and the air scoop such that movement of the actuator plate causes the air scoop to move between the first scoop position and the second scoop position. The linkage mechanism may comprise: a push/pull linkage member coupled to a pivot point on the actuator plate; a rotating linkage member coupled to the push/pull linkage member; and a ball socket linkage coupled between the rotating linkage member and the air scoop.

In some embodiments, a stepper motor is coupled to the lead screw. The stepper motor is configured to rotate the lead screw.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a controllable air inlet system for an aeronautical platform, the system comprising: an actuator plate disposed within a housing of the platform and configured to move forward and rearward along a longitudinal axis of the platform in response to rotation of a lead screw; an inlet panel configured to pivot between a first panel position and a second panel position in response to movement of the actuator plate, the first panel position substantially flush with the housing and the second panel position at least partially interior to the housing; and an air scoop configured to move between a first scoop position and a second scoop position in response to movement of the actuator plate, the first scoop position substantially flush with the housing and the second scoop position at least partially exterior to the housing.

Example 2 includes the system of Example 1, wherein the actuator plate is oriented approximately orthogonally to the longitudinal axis of the platform.

Example 3 includes the system of Examples 1 or 2, wherein the actuator plate comprises a ball tip coupled to a point on the circumference of the actuator plate, and the inlet panel comprises a groove configured to receive the ball tip such that movement of the actuator plate causes the inlet panel to pivot between the first panel position and the second panel position.

Example 4 includes the system of any of Examples 1-3, comprising a linkage mechanism configured to couple the actuator plate to the air scoop such that movement of the actuator plate causes the air scoop to move between the first scoop position and the second scoop position.

Example 5 includes the system of Example 4, wherein the linkage mechanism comprises: a push/pull linkage member coupled to the actuator plate at a first pivot point; a rotating linkage member coupled to the push/pull linkage member at a second pivot point and coupled to the housing at a third pivot point; and a ball socket linkage configured to couple the rotating linkage member to the air scoop.

Example 6 includes the system of any of Examples 1-5, comprising a stepper motor configured to rotate the lead screw.

Example 7 includes the system of any of Examples 1-6, wherein the second panel position and the second scoop position are configured to direct airflow into the platform for combustion by a ramjet motor.

Example 8 includes the system of any of Examples 1-7, wherein the first panel position and the first scoop position are configured to prevent airflow into the platform to control propulsion and to increase aerodynamic efficiency and maneuverability of the platform.

Example 9 is an aeronautical platform comprising: a ramjet motor disposed within a housing of the platform; an inlet panel; an air scoop; and a system configured to control orientation of the air inlet panel and the air scoop, the system comprising an actuator plate disposed within the housing and configured to move forward and rearward along a longitudinal axis of the platform in response to rotation of a lead screw, the inlet panel configured to pivot between a first panel position and a second panel position in response to movement of the actuator plate, the first panel position substantially flush with the housing and the second panel position at least partially interior to the housing, and the air scoop configured to move between a first scoop position and a second scoop position in response to movement of the actuator plate, the first scoop position substantially flush with the housing and the second scoop position at least partially exterior to the housing, such that the second panel position and the second scoop position are configured to direct airflow into the platform for combustion by the ramjet motor.

Example 10 includes the platform of Example 9, wherein the actuator plate is oriented approximately orthogonally to the longitudinal axis of the platform.

Example 11 includes the platform of Examples 9 or 10, wherein the actuator plate comprises a ball tip coupled to a point on the circumference of the actuator plate, and the inlet panel comprises a groove configured to receive the ball tip such that movement of the actuator plate causes the inlet panel to pivot between the first panel position and the second panel position.

Example 12 includes the platform of any of Examples 9-11, comprising a linkage mechanism configured to couple the actuator plate to the air scoop such that movement of the actuator plate causes the air scoop to move between the first scoop position and the second scoop position.

Example 13 includes the platform of Example 12, wherein the linkage mechanism comprises: a push/pull linkage member coupled to the actuator plate at a first pivot point; a rotating linkage member coupled to the push/pull linkage member at a second pivot point and coupled to the housing at a third pivot point; and a ball socket linkage configured to couple the rotating linkage member to the air scoop.

Example 14 includes the platform of any of Examples 9-13, comprising a stepper motor configured to rotate the lead screw.

Example 15 includes the platform of any of Examples 9-14, wherein the first panel position and the first scoop position are configured to prevent airflow into the platform to control propulsion and to increase aerodynamic efficiency and maneuverability of the platform, and the second panel position and the second scoop position are configured to direct airflow into the platform for combustion by a ramjet motor.

Example 16 is a method for fabrication of a controllable air inlet system for an aeronautical platform, the method comprising: disposing an actuator plate within a housing of the platform at an orientation orthogonal to a longitudinal axis of the platform; configuring the actuator plate to move forward and rearward along the longitudinal axis of the platform in response to rotation of a lead screw; configuring an inlet panel to pivot between a first panel position and a second panel position in response to movement of the actuator plate, the first panel position substantially flush with the housing and the second panel position at least partially interior to the housing; and configuring an air scoop to move between a first scoop position and a second scoop position in response to movement of the actuator plate, the first scoop position substantially flush with the housing and the second scoop position at least partially exterior to the housing.

Example 17 includes the method of Example 16, further comprising coupling a ball tip to a point on the circumference of the actuator plate and etching a groove in the inlet panel, the groove configured to receive the ball tip such that movement of the actuator plate causes the inlet panel to pivot between the first panel position and the second panel position.

Example 18 includes the method of Examples 16 or 17, further comprising coupling a linkage mechanism between the actuator plate and the air scoop such that movement of the actuator plate causes the air scoop to move between the first scoop position and the second scoop position.

Example 19 includes the method of Example 18, wherein the linkage mechanism comprises: a push/pull linkage member coupled to the actuator plate at a first pivot point; a rotating linkage member coupled to the push/pull linkage member at a second pivot point and coupled to the housing at a third pivot point; and a ball socket linkage configured to couple the rotating linkage member to the air scoop.

Example 20 includes the method of any of Examples 16-19, comprising coupling a stepper motor to the lead screw, the stepper motor configured to rotate the lead screw.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

1. A controllable air inlet system for an aeronautical platform, the system comprising:
an actuator plate disposed within a housing of a platform and configured to move forward and rearward along a longitudinal axis of the platform in response to rotation of a lead screw;
an inlet panel configured to pivot between a first panel position and a second panel position in response to movement of the actuator plate,
the first panel position substantially flush with the housing and
the second panel position at least partially interior to the housing;
wherein the actuator plate comprises a ball tip coupled to a point on the circumference of the actuator plate, and
the inlet panel comprises a groove configured to receive the ball tip such that movement of the actuator plate causes the inlet panel to pivot between the first panel position and the second panel position;
an air scoop configured to move between a first scoop position and a second scoop position in response to movement of the actuator plate,
the first scoop position substantially flush with the housing and
the second scoop position at least partially exterior to the housing; and
a linkage mechanism configured to couple the actuator plate to the air scoop such that movement of the actuator plate causes the air scoop to move between the first scoop position and the second scoop position, wherein the linkage mechanism comprises:
a push/pull linkage member coupled to the actuator plate at a first pivot point;
a rotating linkage member coupled to the push/pull linkage member at a second pivot point and coupled to the housing at a third pivot point; and
a ball socket linkage configured to couple the rotating linkage member to the air scoop.

2. The system of claim 1, wherein the actuator plate is oriented approximately orthogonally to the longitudinal axis of the platform.

3. The system of claim 1, wherein the actuator plate comprises a ball tip coupled to a point on the circumference of the actuator plate, and the inlet panel comprises a groove configured to receive the ball tip such that the ball tip can slide within the groove and movement of the actuator plate causes the inlet panel to pivot between the first panel position and the second panel position.

4. The system of claim 1, comprising a linkage mechanism configured to couple the actuator plate to the air scoop such that movement of the actuator plate causes the air scoop to move between the first scoop position and the second scoop position.

5. The system of claim 4, wherein the linkage mechanism comprises:
a push/pull linkage member coupled to the actuator plate at a first pivot point;
a rotating linkage member coupled to the push/pull linkage member at a second pivot point and coupled to the housing at a third pivot point; and
a ball socket linkage configured to couple the rotating linkage member to the air scoop, wherein the ball socket linkage comprises a ball joint attached to an end of the ball socket linkage and configured to be received in a socket of the air scoop such that the ball joint can rotate, and a ball joint set screw configured to retain the ball joint within the socket, and wherein the ball socket linkage further comprises a ball joint attached to an opposite end of the ball socket linkage and configured to be received in a socket of the rotating linkage member such that the ball joint attached to the opposite end of the ball socket can rotate, and a ball joint retaining ring configured to retain the ball joint within the socket.

6. The system of claim 1, comprising a stepper motor configured to rotate the lead screw.

7. The system of claim 1, wherein the second panel position and the second scoop position are configured to direct airflow into the platform for combustion by a ramjet motor.

8. The system of claim 1, wherein the first panel position and the first scoop position are configured to prevent airflow into the platform to control propulsion and to increase aerodynamic efficiency and maneuverability of the platform.

9. An aeronautical platform comprising:
a ramjet motor disposed within a housing of a platform;
an inlet panel;
an air scoop; and
a system configured to control orientation of the air inlet panel and the air scoop, the system comprising
an actuator plate disposed within the housing and configured to move forward and rearward along a longitudinal axis of the platform in response to rotation of a lead screw,
wherein the actuator plate comprises a ball tip coupled to a point on the circumference of the actuator plate, and wherein the inlet panel configured to pivot between a first panel position and a second panel position in response to movement of the actuator plate,
wherein the inlet panel comprises a groove configured to receive the ball tip such that movement of the actuator plate causes the inlet panel to pivot between the first panel position and the second panel position,
the first panel position substantially flush with the housing and the second panel position at least partially interior to the housing, and
the air scoop configured to move between a first scoop position and a second scoop position in response to movement of the actuator plate, the first scoop position substantially flush with the housing and the second scoop position at least partially exterior to the housing,
a linkage mechanism configured to couple the actuator plate to the air scoop such that movement of the actuator plate causes the air scoop to move between the first scoop position and the second scoop position,
wherein the linkage mechanism comprises:
a push/pull linkage member coupled to the actuator plate at a first pivot point;
a rotating linkage member coupled to the push/pull linkage member at a second pivot point and coupled to the housing at a third pivot point; and
a ball socket linkage configured to couple the rotating linkage member to the air scoop,
such that the second panel position and the second scoop position are configured to direct airflow into the platform for combustion by the ramjet motor.

10. The platform of claim 9, wherein the actuator plate is oriented approximately orthogonally to the longitudinal axis of the platform.

11. The platform of claim 9, wherein the groove is etched into the inlet panel and configured to receive the ball tip such that movement of the actuator plate causes the ball tip to slide within the groove and to travel along the groove to cause the inlet panel to pivot between the first panel position and the second panel position.

12. The platform of claim 9, wherein the ball socket linkage comprises ball joints coupling the rotating linkage member to the air scoop such that rotation of the rotating linkage member causes the air scoop to move inward or outward of the housing.

13. The platform of claim 12, wherein the ball socket linkage comprises:
a first ball joint attached to an end of the ball socket linkage and configured to be received in a socket of the air scoop;
a ball joint set screw configured to retain the first ball joint withing the socket of the air scoop while allowing the first ball joint to rotate;
a second ball joint attached to an opposite end of the ball socket linkage and configured to be received in a socket of the rotating linkage member; and
a ball joint retaining ring configured to retain the second ball joint within the socket of the rotating linkage member while allowing the second ball joint to rotate.

14. The platform of claim 9, comprising a stepper motor configured to rotate the lead screw.

15. The platform of claim 9, wherein the first panel position and the first scoop position are configured to prevent airflow into the platform to control propulsion and to increase aerodynamic efficiency and maneuverability of the platform, and the second panel position and the second scoop position are configured to direct airflow into the platform for combustion by the ramjet motor.

16. A method for fabrication of a controllable air inlet system for an aeronautical platform, the method comprising:
disposing an actuator plate within a housing of a platform at an orientation orthogonal to a longitudinal axis of the platform;
configuring the actuator plate to move forward and rearward along the longitudinal axis of the platform in response to rotation of a lead screw;
configuring an inlet panel to pivot between a first panel position and a second panel position in response to movement of the actuator plate,
the first panel position substantially flush with the housing and
the second panel position at least partially interior to the housing;
coupling a ball tip to a point on the circumference of the actuator plate and etching a groove in the inlet panel, the groove configured to receive the ball tip such that movement of the actuator plate causes the inlet panel to pivot between the first panel position and the second panel position;
configuring an air scoop to move between a first scoop position and a second scoop position in response to movement of the actuator plate,
the first scoop position substantially flush with the housing and
the second scoop position at least partially exterior to the housing; and
coupling a linkage mechanism between the actuator plate and the air scoop such that movement of the actuator plate causes the air scoop to move between the first scoop position and the second scoop position, wherein the linkage mechanism comprises:
a push/pull linkage member coupled to the actuator plate at a first pivot point;
a rotating linkage member coupled to the push/pull linkage member at a second pivot point and coupled to the housing at a third pivot point; and
a ball socket linkage configured to couple the rotating linkage member to the air scoop.

17. The method of claim 16, further comprising coupling a ball tip to a point on the circumference of the actuator plate and etching a groove in the inlet panel, the groove configured to receive the ball tip such that the ball tip can slide within the groove and movement of the actuator plate causes the inlet panel to pivot between the first panel position and the second panel position.

18. The method of claim 16, further comprising coupling a linkage mechanism between the actuator plate and the air scoop such that movement of the actuator plate causes the air scoop to move between the first scoop position and the second scoop position.

19. The method of claim 18, wherein the linkage mechanism comprises:
a push/pull linkage member coupled to the actuator plate at a first pivot point;
a rotating linkage member coupled to the push/pull linkage member at a second pivot point and coupled to the housing at a third pivot point; and
a ball socket linkage configured to couple the rotating linkage member to the air scoop, wherein the ball socket linkage comprises a ball joint attached to an end of the ball socket linkage and configured to be received in a socket of the air scoop such that the ball joint can rotate, and a ball joint set screw configured to retain the ball joint within the socket, and wherein the ball socket linkage further comprises a ball joint attached to an opposite end of the ball socket linkage and configured to be received in a socket of the rotating linkage member such that the ball joint attached to the opposite end of the ball socket can rotate, and a ball joint retaining ring configured to retain the ball joint within the socket.

20. The method of claim 16, comprising coupling a stepper motor to the lead screw, the stepper motor configured to rotate the lead screw.
